(19) United States
(12) Patent Application Publication
(10) Pub. No.: US 2018/0305012 A1
(43) Pub. Date: Oct. 25, 2018

(54) METHOD FOR CONTROLLING SMALL-SIZE UNMANNED AERIAL VEHICLE

(71) Applicant: PRODRONE CO., LTD., Nagoya-shi, Aichi (JP)

(72) Inventor: Kazuo ICHIHARA, Nagoya-shi (JP)

(73) Assignee: PRODRONE CO., LTD., Nagoya-shi, Aichi (JP)

(21) Appl. No.: 15/768,785

(22) PCT Filed: Oct. 7, 2016
(86) PCT No.: PCT/JP2016/079915

§ 371 Date: Apr. 16, 2018

(30) Foreign Application Priority Data
Oct. 16, 2015 (JP) 2015-204303

(51) Int. Cl. B64C 39/02; G05D 1/10; G05D 1/00; G06K 9/00

(52) U.S. Cl. CPC B64C 39/024; G05D 1/101; G05D 1/0094; G08G 5/045; B64C 2201/145; B64C 2201/024; G06K 9/00536

(57) ABSTRACT

A method for controlling a small-size unmanned aerial vehicle that sets a flight path based on a real-time state of the ground and that controls the small-size unmanned aerial vehicle to fly through the flight path. The small-size unmanned aerial vehicle includes: a plurality of propellers; and a photographing device configured to take an image of a ground below the photographing device. The method includes: an information obtaining step of moving the small-size unmanned aerial vehicle upward from the ground and photographing a state of the ground using the photographing device so as to obtain the image of the ground; a path setting step of setting, over the image, a flight path for the small-size unmanned aerial vehicle to fly through; and a flying step of causing the small-size unmanned aerial vehicle to fly through the flight path.

### TECHNICAL FIELD

The present invention relates to a method for controlling a small-size unmanned aerial vehicle. More specifically, the present invention relates to a method for control that sets a flight path for a small-size unmanned aerial vehicle and that controls the small-size unmanned aerial vehicle to fly through the flight path.

### BACKGROUND ART

In aircrafts such as airplanes, a known system sets a flight path for an aircraft and automatically controls the aircraft to fly through the flight path. Another known system helps an operator to operate the aircraft through the flight path. These kinds of systems set and control flight paths based on known topography information and/or map information, as disclosed in patent literature 1, for example.

In recent years, there has been a rapid rise in popularity of small-size unmanned aerial vehicles (UAVs) represented by industrial unmanned helicopters, especially small-size multi-copters. This has led to attempts to introduce UAVs to a wide range of fields. A multi-copter is a kind of helicopter that is equipped with a plurality of rotors and that flies while maintaining a balance of the airframe by adjusting the rotational speed of each of the rotors. Also, a mechanism that is being put into practice is that a small-size unmanned aerial vehicle is controlled to fly autonomously within a predetermined range using a Global Navigation Satellite System (GNSS), represented by GPS, and using an altitude sensor, instead of by the operator's operation.

In this kind of small-size unmanned aerial vehicle as well, a flight path may in some cases be set based on topography information and/or map information. For example, a method that is in practice is to set a desired path over a public aerial photograph available on the Internet or another network (for example, Google map), and to control a small-size unmanned aerial vehicle to make an autonomous flight through the path.

### CITATION LIST

### Patent Literature

JP 2004-233082 A

### SUMMARY OF INVENTION

### Technical Problem

Public aerial photographs available on the Internet or another network are information photographed at some point in time and intended for use over a predetermined period of time. That is, public aerial photographs do not reflect information changing from moment to moment. In some places, available information may be as old as a few or several months, or even more than one year. Therefore, at the point of time when an aerial photograph of the ground is used, the ground may have changed from what it was at the point of time when the aerial photograph was taken. Examples of such change include construction of new buildings, change in how plants are growing, and change in topography caused by natural disasters.

In setting a flight path for a small-size unmanned aerial vehicle using an aerial photograph of the ground, if the ground has changed from what it was at the point of time when the aerial photograph was taken, the change may adversely affect the flight of the small-size unmanned aerial vehicle through the flight path that has been set. For example, a building that did not exist at the point of time when the aerial photograph was taken may have been constructed somewhere along the flight path that has been set. For further example, a tree may have grown greatly since the aerial photograph was taken. In these examples, the small-size unmanned aerial vehicle flying through the flight path that has been set may collide with the building and/or the tree.

A problem to be solved by the present invention is to provide such a method for controlling a small-size unmanned aerial vehicle that sets a flight path based on a real-time state of the ground and that controls the small-size unmanned aerial vehicle to fly through the flight path.

### Solution to Problem

In order to solve the above-described problem, the present invention provides a method for controlling a small-size unmanned aerial vehicle. The small-size unmanned aerial vehicle includes: a plurality of propellers; and a photographing device configured to take an image of a ground below the photographing device. The method includes: an information obtaining step of moving the small-size unmanned aerial vehicle upward from the ground and photographing a state of the ground using the photographing device so as to obtain the image of the ground; a path setting step of setting, over the image, a flight path for the small-size unmanned aerial vehicle to fly through; and a flying step of causing the small-size unmanned aerial vehicle to fly through the flight path.

The flying step may include causing the small-size unmanned aerial vehicle to make an autonomous flight of autonomously controlling a flight position of the small-size unmanned aerial vehicle.

The path setting step may include setting the flight path over the image by setting a plurality of reference points for the small-size unmanned aerial vehicle to pass. The flying step may include causing the small-size unmanned aerial vehicle to fly based on a positional relationship among the plurality of reference points.

The flying step may include performing image pattern recognition to associate the flight path set over the image with a path through which the small-size unmanned aerial vehicle actually flies.

The information obtaining step may include causing the small-size unmanned aerial vehicle to take the image at a fixed point using the photographing device.

### Advantageous Effects of Invention

In the method according to the above-described invention for controlling a small-size unmanned aerial vehicle, a step performed first is an information obtaining step of aerially photographing a real-time state of the ground so as to obtain an image. Then, in a path setting step, a flight path is set over the image. Thus, the set flight path is based on an actual state of the ground at the point of time when the image was taken. For example, a flight path can be set to avoid collision or contact with an obstacle that actually exists at the present point of time. Then, in a flying step, the small-size unmanned aerial vehicle is caused to actually fly through the flight path that has been set. This enables a real-time state of the ground to be taken into consideration, resulting in a flight without collision or contact with an obstacle.

In the flying step, the small-size unmanned aerial vehicle is caused to make an autonomous flight of autonomously controlling a flight position of the small-size unmanned aerial vehicle. This necessitates setting, prior to the autonomous flight, a suitable flight path that serves as a basis of the autonomous flight. In light of this, the above-described image taken in the information obtaining step is used as basic information. This enables a suitable flight path to be set in the path setting step, resulting in an autonomous flight that is highly accurate enough to reliably avoid collision with an obstacle during the autonomous flight.

In the path setting step, the flight path is set over the image by setting a plurality of reference points for the small-size unmanned aerial vehicle to pass. In the flying step, the small-size unmanned aerial vehicle is caused to fly based on a positional relationship among the plurality of reference points. In causing the small-size unmanned aerial vehicle to fly according to the flight path that has been set, these steps ensure that once the small-size unmanned aerial vehicle has passed the first reference point, the small-size unmanned aerial vehicle is able to fly through the rest of the path based solely on information of the image taken in the information obtaining step, without relying on external information such as GNSS information. This prevents deviation of the flight path, which may otherwise be caused by an external factor such as a GNSS signal error.

In the flying step, image pattern recognition is performed to associate the flight path set over the image with a path through which the small-size unmanned aerial vehicle actually flies. This is performed by associating, based on shape or another characteristic of an object included in the image, the flight path over the image with an actual flight path over the ground. If this associating operation is performed based on position information, an occurrence such as distortion of the lens of the photographing device may cause an error when the position on the image is converted into an actual position on the ground. Use of image pattern information, on the other hand, enables the small-size unmanned aerial vehicle to fly with high accuracy through the flight path that has been set over the image, without being affected by the above-described photographing state or another state.

In the information obtaining step, the small-size unmanned aerial vehicle is caused to take the image at a fixed point using the photographing device. This ensures a simplified image used in the setting of the flight path.

### BRIEF DESCRIPTION OF DRAWINGS

FIG. 1 is a schematic perspective view of an external appearance of an exemplary small-size unmanned aerial vehicle to which a control method according to an embodiment of the present invention is applied.

FIG. 2 is a block diagram illustrating a schematic of the small-size unmanned aerial vehicle.

FIG. 3 is a conceptual diagram illustrating an information obtaining step of a method according to an embodiment of the present invention for controlling a small-size unmanned aerial vehicle.

FIG. 4 is a diagram illustrating an image over which a flight path is set in a path setting step of the control method.

FIG. 5 is a conceptual diagram illustrating a part of a flying step of the control method.

FIG. 6 is a diagram illustrating an existing aerial photograph over which a flight path is set.

### DESCRIPTION OF EMBODIMENTS

A method according to an embodiment of the present invention for controlling a small-size unmanned aerial vehicle will be described below in detail by referring to the drawings. The method according to this embodiment for controlling a small-size unmanned aerial vehicle is directed to a control method for setting a path for the small-size unmanned aerial vehicle to fly through and for causing the small-size unmanned aerial vehicle to fly through the path.

### [Configuration of Small-Size Unmanned Aerial Vehicle]

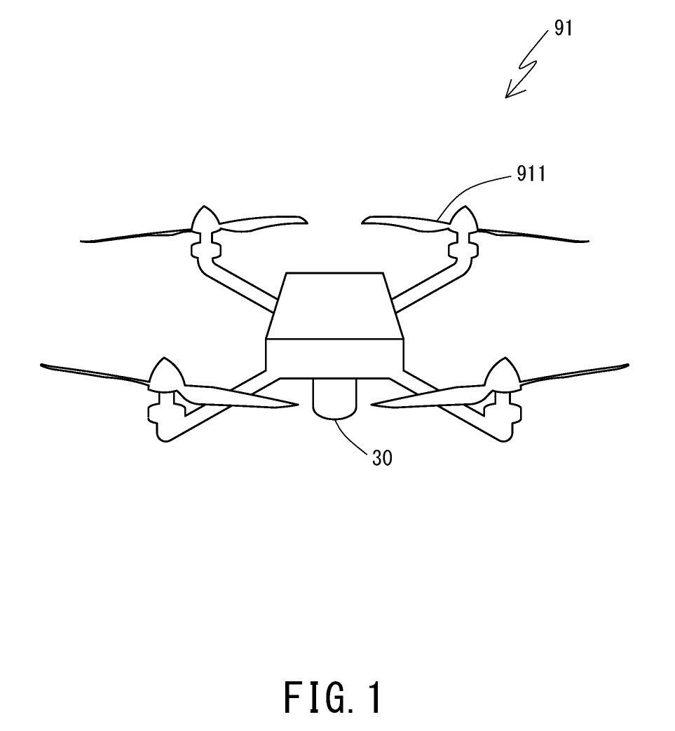

FIG. 1 is a schematic perspective view of an external appearance of a multi-copter (small-size unmanned aerial vehicle) 91, to which a control method according to an embodiment of the present invention is applied. The multi-copter 91 is an aircraft that includes a plurality of (in this embodiment, four) propellers 911. The multi-copter 91 includes a camera (photographing device) 30 at a lower portion of the multi-copter 91. The camera 30 is mounted with its photographing surface facing downward so that the camera 30 is able to photograph a region below the multi-copter 91.

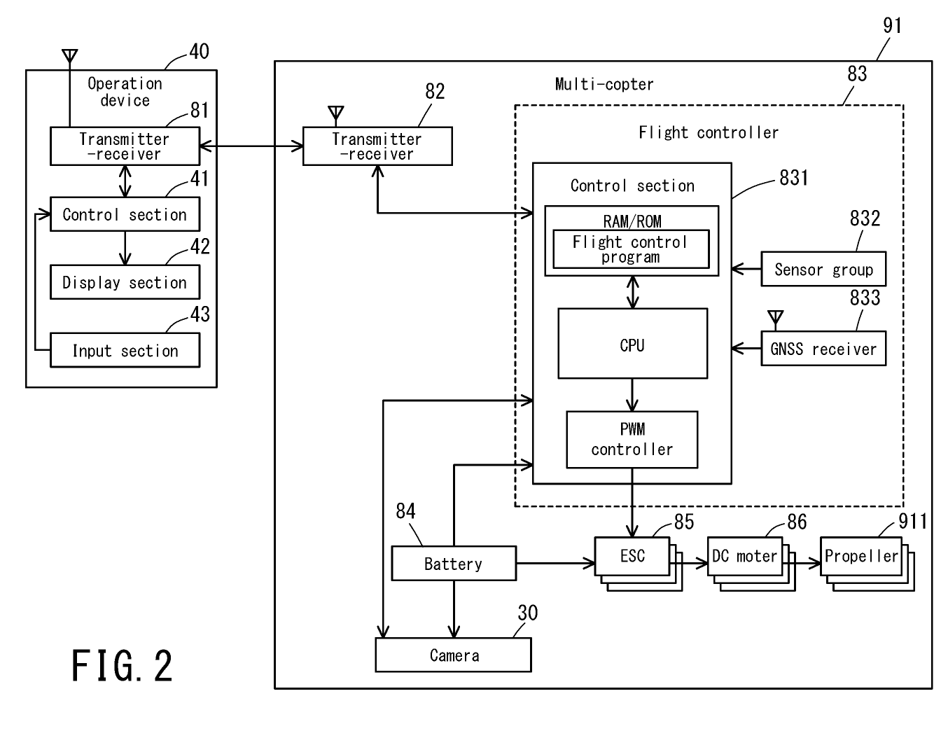

FIG. 2 is a block diagram illustrating a functional configuration of the multi-copter 91. The multi-copter 91 mainly includes: a flight controller 83, which controls the posture and flight operation of the multi-copter 91 in the air; the plurality of propellers 911, which rotate to generate lift force of the multi-copter 91; a transmitter-receiver 82, which has wireless communication with an operator (transmitter-receiver 81); the camera 30, which serves as a photographing device; and a battery 84, which supplies power to these elements.

The flight controller 83 includes a control section 831, which is a micro-controller. The control section 831 includes: a CPU, which is a central processing unit; a RAM/ROM, which is a storage device; and a PWM controller, which controls DC motors 86. Each of the DC motors 86 is connected to a corresponding one of the propellers 911, and at a command from the PWM controller, the rotational speed of each DC motor 86 is controlled via an ESC (Electric Speed Controller) 85. By adjusting a balance between the rotational speeds of the four propellers 911, the posture and movement of the multi-copter 91 are controlled.

The flight controller 83 includes a sensor group 832 and a GNSS receiver 833, which are connected to the control section 831. The sensor group 832 of the multi-copter 91 includes an acceleration sensor, a gyro sensor (angular velocity sensor), a pneumatic sensor, and a geomagnetic sensor (electronic compass).

The RAM/ROM of the control section 831 stores a flight control program in which a flight control algorithm associated with a flight of the multi-copter 91 is described. Based on information obtained from the sensor group 832, the control section 831 is capable of controlling the posture and position of the multi-copter 91 using the flight control program. In this embodiment, the operator is able to manually perform the flight operation of the multi-copter 91 via the transmitter-receiver 81. The RAM/ROM also stores an autonomous flight program in which flight plans such as flight position (GNSS coordinates and altitude) and flight route are described as parameters so that the multi-copter 91 makes an autonomous flight (autopilot).

The camera 30 takes an image upon receipt of a command from the control section 831. Then, the image I taken by the camera 30 transmitted to the transmitter-receiver 81, which is at the operator's side, via the control section 831 and the transmitter-receiver 82.

To the multi-copter 91, a separate operation device 40 is attached, which is remotely operable by the operator. The operation device 40 includes, in addition to the transmitter-receiver 81: a control section 41, which performs arithmetic operation and control processing using elements such as CPU; a display section 42, which displays an image; and an input section 43, via which the operator inputs parameters or other inputs. For example, it is possible to use a touch panel as a device that serves both as the display section 42 and the input section 43. The image taken by the camera 30 and transmitted via the transmitter-receiver 81 is displayed on the display section 42. The input section 43 receives control parameters input by the operator to manually control a flight of the multi-copter 91, as described above. In addition, the input section 43 is used to make an autopilot flight; flight conditions are specified on the image displayed on the display section 42, such as a flight path R through which the multi-copter 91 is intended to make an autonomous flight. It is also possible for the operator to, using the input section 43, instruct the camera 30 to take an image and/or change photographing conditions.

[Method for Controlling Small-Size Unmanned Aerial Vehicle]

Next, description will be made with regard to a control method according to an embodiment of the present invention applied to the above-described multi-copter 91.

In the control method according to this embodiment, (1) information obtaining step, (2) path setting step, and (3) flying step are performed in this order. In (1) information obtaining step, information that serves as a basis of control is obtained regarding a state of the ground in a region in which the multi-copter 91 is intended to fly. Then, in (2) path setting step, a path through which the multi-copter 91 is intended to fly is set based on the obtained information. Lastly, in (3) flying step, the multi-copter 91 is actually caused to fly based on the path that has been set. These steps are performed continuously, that is, upon completion of a previous step, the next step starts immediately. In this respect, the concept of “continuous” or “immediate” encompasses a configuration in which a time interval is set to a degree in which no substantial change occurs to an object (natural object and artificial object) having a possibility of affecting the flight of the multi-copter 91 on the ground in a region in which the multi-copter 91 is caused to fly. Typically, such time interval has a tolerance of a few or several hours or even a tolerance of approximately one day. Also, insofar as the order of the three steps is coherent, some another step may intervene, such as maintenance of the multi-copter 91. Each of the steps will be described below.

### (1) Information Obtaining Step

In the information obtaining step, the multi-copter 91 is moved upward from the ground, and the camera 30 aerially photographs a state of the ground. Thus, an image I is obtained. Specifically, the operator uses the operation device 40 to lift the multi-copter 91 and instruct the camera 30 to take an image at a suitable position. In the meantime, the multi-copter 91 stays at a fixed point in the air (hovering) and uses the camera 30, which is disposed at a lower portion of the multi-copter 91, to photograph a state of the ground immediately below the camera 30 in a vertical direction. Thus, the obtained image I shows a state of the ground within the range of a field of vision F of the camera 30. It is noted that the “fixed point” may have a degree of positional tolerance with which the image I still has a necessary level of resolution.

The position at which the multi-copter 91 takes the image I may be selected in such a manner that the range of the flight that the multi-copter 91 is intended to make in the later flying step is included within the image I. In particular, the position in the height direction may be determined such that the entire range of the flight that the multi-copter 91 is intended to make is included within the field of vision F of the camera 30.

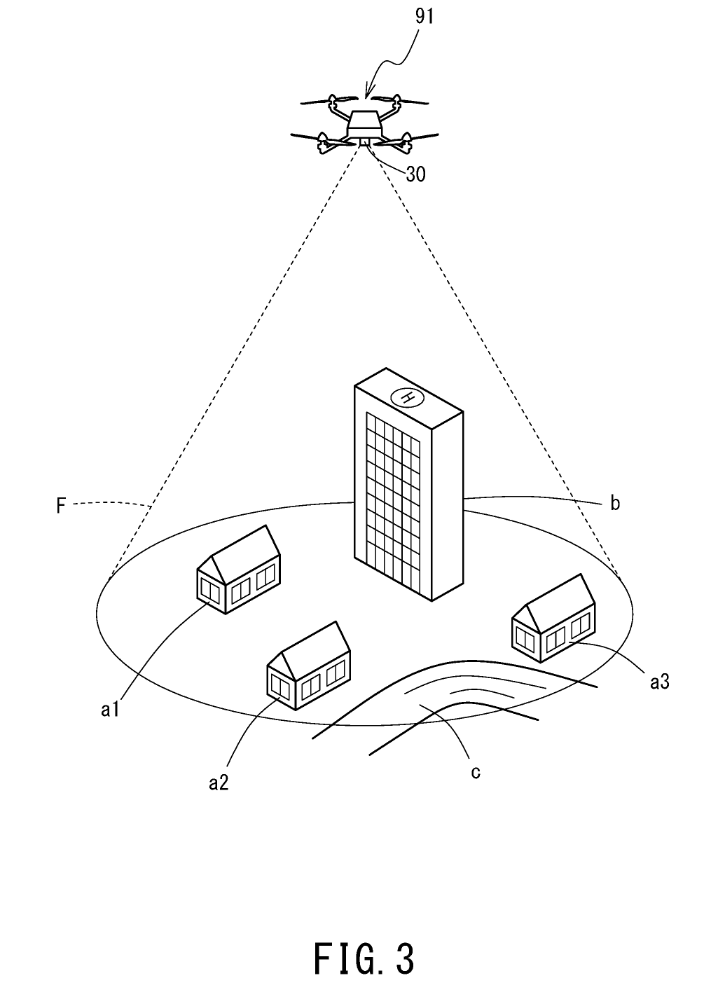

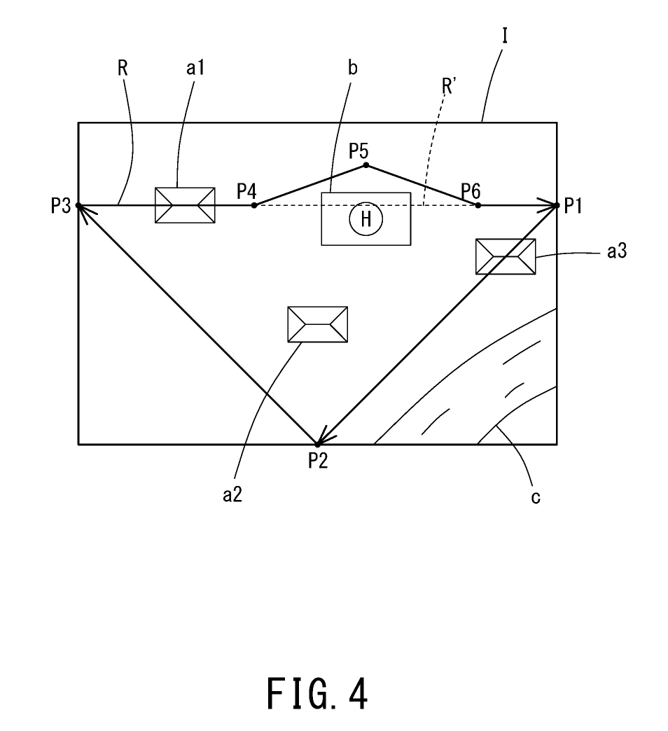

The image I taken by the camera 30 in this step is transmitted to the operation device 40 via the transmitter-receivers 81, 82. This enables the operator to check the image I on the display section 42. For example, the region illustrated in FIG. 3 includes residential houses a1 to a3, a building b, and a river c. When this region is included within the field of vision F and photographed by the camera 30, the obtained image I is as illustrated in FIG. 4, which is displayed on the display section 42.

It is noted that the image I may be obtained by a photographing operation with the multi-copter 91 moving, instead of by the photographing operation performed at a fixed point with respect to the ground immediately below the multi-copter 91 in the vertical direction. For example, when a wide photographing range is desired, it is possible to take, at a plurality of fixed points, images of the ground immediately below the multi-copter 91 in the vertical direction and to combine the taken images together to constitute one large image I. For further example, it is possible to construct an image I by three-dimensional mapping, which can be implemented by moving the multi-copter 91 to cause the camera 30 to perform a photographing operation in varied photographing directions and by performing suitable image processing. Thus, three-dimensional information is obtained, such as the height of an object that can be an obstacle to the flight of the multi-copter 91. This increases the amount of information available in the path setting step and flying step that follow. It is noted, however, that images obtained by currently known three-dimensional mapping are hardly superior in quality, and thus are not advantageously convenient over two-dimensional images in the path setting step and flying step that follow. In light of the circumstances, it is more practical in terms of simplicity to obtain the image I by two-dimensionally photographing the ground immediately below the multi-copter 91 in the vertical direction at a fixed point, as described above. While in the above description the control of the multi-copter 91 in the information obtaining step is performed manually by the operator, the control may be performed by an autonomous flight. It is noted that when the multi-copter 91 is moved for the purpose of a photographing operation at a plurality of fixed points and/or for the purpose of three-dimensional mapping, it is necessary to avoid contact or collision with an obstacle or another object existing on the ground. For this purpose, it is necessary to cause the multi-copter 91 to fly at a position that is sufficiently higher than the height of an obstacle that may possibly exist, or it is necessary to cause the multi-copter 91 to fly by a manual operation while carefully checking the position of the multi-copter 91.

### (2) Path Setting Step

Next, in the path setting step, a flight path R, through which the multi-copter 91 is intended to fly in the flying step that follows, is set based on the image I obtained in the information obtaining step. Specifically, on the image I displayed on the display section 42, the operator specifies waypoints (reference points) that the operator wants the multi-copter 91 to pass in the air. For each of the waypoints, the operator specifies an altitude at which the multi-copter 91 is intended to fly, and also specifies an operation, if any, that the operator wants the multi-copter 91 to perform, such as photographing, landing, and dropping of an article. While the operator is performing the path setting operation, the multi-copter 91 may be caused to wait in the air or temporarily return to the ground.

In specifying waypoints on the image I, it is necessary to prevent an obstacle existing on the ground from making collision, contact, a too close approach, or similar movement with respect to the multi-copter 91. For example, when, in the example illustrated in FIG. 3, the multi-copter 91 is intended to fly at an altitude higher than the residential houses a1 to a3 but lower than the building b, it is necessary to cause the multi-copter 91 to fly at a position sufficiently distanced from the building b in a horizontal direction or, when the multi-copter 91 needs to fly adjacent to the building b, cause the multi-copter 91 to circumvent the building b in a horizontal direction or a vertical direction.

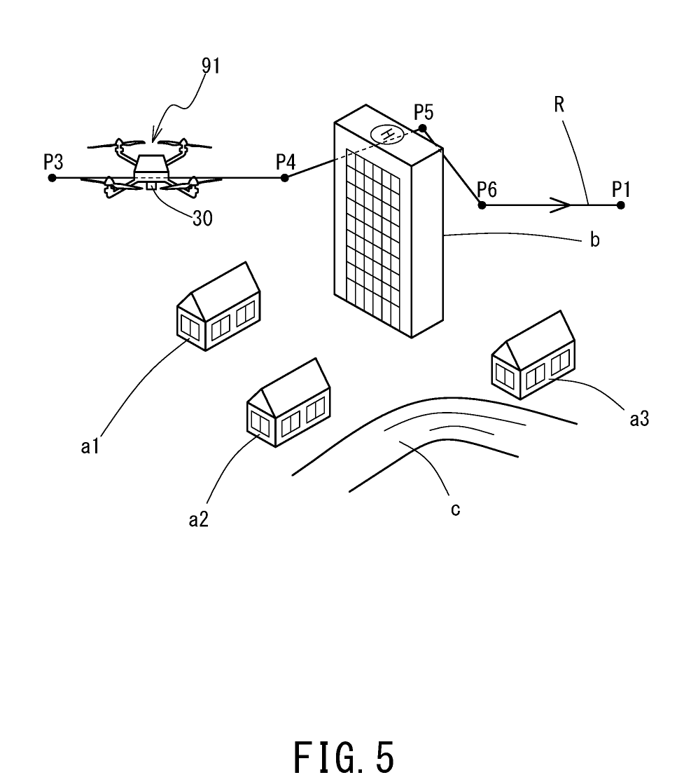

For example, in FIG. 4, the flight path R is set by arranging waypoints P1 to P6 on the image I. Here, the multi-copter 91 is intended to start the first waypoint P1, pass two waypoints P2, P3 in this order, and return to the first waypoint P1. As indicated by the dotted line, however, if a linear flight path R′ is set between the waypoint P3 and the waypoint P1, the flight path R′ overlaps the building b. This makes it possible for the multi-copter 91 to collide with the building b if the multi-copter 91 flies according to the flight path R′ in the flying step that follows. In light of this, waypoints P4 to P6 are arranged, in addition to the waypoints P1 to P3. Then, a flight path R of P1→P2→P3→P4→P5→P6→P1 is set. This enables the multi-copter 91 to circumvent the building b, making a flight without collision, contact, or similar occurrence with respect to the building b, even if the flight is at an altitude lower than the building b (FIG. 5).

In the above-described example, the flight path R is adjusted in a horizontal direction to circumvent the building b in an attempt to avoid collision or contact with the building b. It is also possible to adjust the flight path R in a vertical direction to avoid collision or contact with the building b, such as by increasing the altitude of the flight path R when passing a horizontal position at which the building b exists or passing a position near the horizontal position. It is also possible to use both a horizontal adjustment and a vertical adjustment.

### (3) Flying Step

In the flying step that follows, the multi-copter 91 is caused to actually fly through the flight path R that has been set in the above-described manner. The multi-copter 91 flies while connecting the waypoints P1 to P6 to each other in horizontal directions according to altitudes set for the waypoints P1 to P6 in vertical directions. At each of the waypoints P1 to P6, the multi-copter 91 performs an operation such as photographing, landing, and dropping of an article, if such operation is specified. In the information obtaining step, the multi-copter 91 is waiting up in the air. In starting the flying step, the multi-copter 91 may change from the waiting state directly to a flight through the flight path R, or may temporarily return to the ground and lift again.

In the flying step, the operator may manually control a motion of the multi-copter 91 by referring to the flight path R set in the path setting step. It is more preferable, however, to cause the multi-copter 91 to fly autonomously by autopilot through the flight path R that has been set, because of the following reason. In this case, information concerning, for example, the flight path R that has been set in the path setting step is input into the control section 831 of the multi-copter 91 from the operation device 40 via the transmitter-receivers 81, 82. With this information reflected in the flight control program, the multi-copter 91 is caused to perform autopilot control. In the path setting step, detailed flight conditions such as the flight path R have been set. In addition, the flight path R has been set to avoid contact with an obstacle such as the building b. This ensures that by implementing, by autopilot, the flight conditions such as the flight path R that has been set, the multi-copter 91 can be caused to fly through the flight path R highly accurately and readily while avoiding unexpected occurrences such as collision with an obstacle.

In this respect, it is necessary to cause the control section 831 of the multi-copter 91 to recognize the waypoints P1 to P6 set on the image I in the path setting step as actual points on the ground, and to cause the multi-copter 91 to move through each of the points. A possible approach to this is to use a processing method that converts the positions of the waypoints P1 to P6 on the image I into coordinate values (latitude and longitude) as absolute values on the ground. However, GNSS signals, such as GPS signals, used to manage coordinate values are currently known to have inevitable errors depending on time, season, ionospheric conditions, surrounding environment, and other conditions. If coordinate values are used to recognize the positions that the multi-copter 91 is intended to pass, the path through which the multi-copter 91 actually flies may deviate. Therefore, even though the flight path R has been set to avoid an obstacle in the path setting step, the deviation may cause inconvenient situations in which, for example, the obstacle cannot be avoided sufficiently as intended. In light of this, the plurality of waypoints P1 to P6 set on the image I are recognized based on a positional relationship among the waypoints P1 to P6, instead of recognizing the waypoints P1 to P6 as absolute coordinate values. A positional relationship among the plurality of waypoints P1 to P6 on the image I is uniquely determined as self-contained information; insofar as the first waypoint (in the example illustrated in the figure, the waypoint P1) is passed correctly, the rest (P2 to P6) of the waypoints can be tracked without influence of flight position deviation that is otherwise caused by external factors such as a GNSS signal. It is noted that GNSS information may be used as position information supplemental to the positional relationship among the waypoints P1 to P6, and that this supplemental information can be used for examination of actual position control. In particular, in a measurement lasting only a short period of time, GNSS information does not fluctuate greatly and thus can be used for examination of relative position accuracy.

Further, an operation of associating the flight path R that has been set on the image I with the path through which the multi-copter 91 actually flies is performed. This is preferably performed by recognizing an image pattern on the image I and associating the image pattern with an actual structure pattern on the ground, instead of recognizing the waypoints P1 to P6 by converting the positions of the waypoints P1 to P6 on the image I into positions on the ground. The term image pattern refers to shape or color, particularly shape, of an object (natural object and artificial object) included in the image taken by the camera 30, examples of the object including roofs of the residential houses a1 to a3 and the river c. The association operation may be performed by checking an image pattern in the image I taken in advance by the camera 30 in the information obtaining step against an image pattern in an image taken in a real-time manner by the camera 30 in the flying step.

In the camera 30, a lens may have an aberration, a distortion, or another defect. This may cause the relationship between the distance between two points in the obtained image and the distance between two points on an actual photographing target, such as the ground, to vary from portion to portion of the image. For example, a distance in an actual photographing target tends to be longer than a corresponding length in the image as a portion of the image is closer to the edge of the image than to the center of the image. In light of this, in order to accurately convert the positions of the waypoints P1 to P6 on the image I into positions on the ground, it is necessary to make corrections taking characteristics of an individual camera 30 into consideration. An approach in contrast to this is to recognize the image as a pattern and associate a pattern of arbitrary points on the flight path R, such as the waypoints P1 to P6 on the image, with a pattern of the actual ground. This eliminates the need for the corrections and simplifies the step involved in the control of causing the multi-copter 91 to accurately fly through the flight path R that has been set. This method of using an image pattern as a position reference is used in applications such as topographic survey under the concept of GCP (Ground Control Point). It is noted that from the viewpoint of more accurate position control to be performed with respect to the multi-copter 91, it is possible to use both image pattern-based recognition and position information-based recognition to associate the flight path R on the image I with the path through which the multi-copter actually flies. In this case, a positional relationship among the waypoints P1 to P6, and even GNSS information, may be used as position information, as described above.

Thus, in the control method according to this embodiment, information prepared in advance, such as an aerial photograph and other existing information, is not used to set a flight path for the multi-copter 91. Instead, a real-time state of the ground is checked in the information obtaining step, and then immediately, a flight path R is specified in the path setting step. Then, in the flying step, the multi-copter 91 is caused to actually fly through the flight path R. This ensures recognition of the building b in the above-described example or another object that actually exists at the present point of time and that can be an obstacle to the flight of the multi-copter 91. Then, the flight path R is specified to avoid contact or collision with the object, and the multi-copter 91 is caused to actually fly through the flight path R.

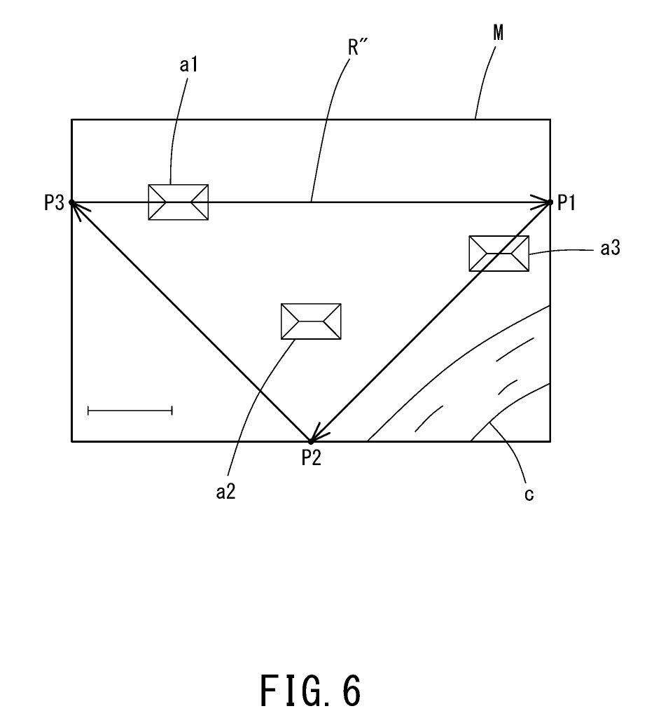

FIG. 6 illustrates a case where a flight path is set without the immediately preceding information obtaining step but using an aerial photograph M, which is existing topography information or map information available on the Internet or another network. In this case, a real-time state of the ground may not necessarily be accurately taken in the aerial photograph M or other information. For example, assume a case where the building b was not built yet at the time when the aerial photograph M was taken, although the building b actually exists as illustrated in FIG. 3. In this case, the building b is regarded as nonexistent in the existing aerial photograph M, as illustrated in FIG. 6. A flight path R″ passes three waypoints P1 to P3 at an altitude higher than the residential houses a1 to a3. When such flight path R″ is desired to be set based on the aerial photograph M, it is common practice to set a linear path of P1→P2→P3→P1. Even if, however, the multi-copter 91 is caused to actually fly through the flight path R″ that has been set, there is the building b, which is not recognized in the aerial photograph M, existing somewhere along the path of P3→P1. As a result, if the multi-copter 91 is at an altitude lower than the building b, the multi-copter 91 may collide with the building b.

In the control method including the above-described information obtaining step, such occurrence is avoided by checking the flight path R based on information of the ground obtained immediately before the flight. In particular, in associating the waypoints P1 to P6 set on the image I with actual points on the ground, a positional relationship among the waypoints P1 to P6 is used, instead of using absolute coordinate values of the waypoints P1 to P6, as described above. Further, image pattern recognition is used in the association operation. This enables the multi-copter 91 to accurately fly through the flight path R that has been set.

The multi-copter 91 may also include a distance measuring sensor that measures distances to surrounding objects. In this case, in the path setting step, a flight path R may be set on the image I to avoid an obstacle, as described above, and in the flying step, the multi-copter 91 may be caused to fly while the distance measuring sensor at any time measures the distance to the obstacle so as to make a real-time check as to whether there is a possibility of actual contact with the obstacle. However, specifying the flight path R based on the image I obtained in the immediately preceding step, as described above, eliminates the need for this real-time detection of an obstacle and still ensures obstacle avoidance at a sufficiently high level of accuracy. Thus, using the control method according to this embodiment ensures a flight with a highly accurate positional relationship with an obstacle or another surrounding object, even if the multi-copter is a multi-copter without a distance measuring sensor or a low-price multi-copter inferior in performance.

In the control method according to this embodiment, the three steps made up of the information obtaining step, the path setting step, and the flying step are performed continuously. This control method can be used not only to avoid an obstacle in the flying step but also in a variety of applications where it is effective to grasp an actual state of the ground at the point of time when the multi-copter 91 flies. For example, assume a case where it is necessary to identify, from a wide range of area, a place having a particular state and to perform an operation with respect to the identified place. In this case, in the information obtaining step, an image I of a wide range of area may be taken, and a place having a particular state may be identified in the image I. Then, in the path setting step, a flight path R toward the place may be set on the image I, and in the flying step, the multi-copter 91 may be caused to fly toward the place. A specific example is to find out a missing accident victim, and after finding out the victim, to photograph details of the environment surrounding the place where the victim is located or drop goods to the place. In this case, it is possible to make a guess as to where in the image I of a wide range of area the missing accident victim is and to cause the multi-copter 91 to fly to the place. In particular, the control method according to this embodiment is useful in disasters or other occurrences where the state of the ground can change greatly in a short period of time.

An embodiment of the present invention has been described hereinbefore. The present invention, however, will not be limited to the above-described embodiment but may have various modifications without departing from the scope of the present invention.

1. A method for controlling a small-size unmanned aerial vehicle, the small-size unmanned aerial vehicle comprising: a plurality of propellers; and a photographing device configured to take an image of a ground below the photographing device, the method comprising:
an information obtaining step of moving the small-size unmanned aerial vehicle upward from the ground and photographing a state of the ground using the photographing device so as to obtain the image of the ground;
a path setting step of setting, over the image, a flight path for the small-size unmanned aerial vehicle to fly through; and
a flying step of causing the small-size unmanned aerial vehicle to fly through the flight path,
wherein the path setting step comprises setting the flight path over the image by setting a plurality of reference points for the small-size unmanned aerial vehicle to pass, and the flying step comprises causing the small-size unmanned aerial vehicle to fly based on a positional relationship among the plurality of reference points, and
wherein the flying step comprises associating the flight path set over the image with a path through which the small-size unmanned aerial vehicle actually flies by, instead of converting the plurality of reference points into actual positions on the ground, recognizing an image pattern of at least one of a color and a shape of an object selected from a natural object and an artificial object included in the image that the photographing device mounted on the small-size unmanned aerial vehicle with a photographing surface of the photographing device facing downward has taken as the state of the ground immediately below the photographing device in a vertical direction.

2. The method for controlling the small-size unmanned aerial vehicle according to claim 1, wherein the flying step comprises causing the small-size unmanned aerial vehicle to make an autonomous flight of autonomously controlling a flight position of the small-size unmanned aerial vehicle.

3. The method for controlling the small-size unmanned aerial vehicle according to claim 1, wherein the information obtaining step comprises causing the small-size unmanned aerial vehicle to take the image at a fixed point using the photographing device.

4. A method for controlling a small-size unmanned aerial vehicle, the small-size unmanned aerial vehicle comprising: a plurality of propellers; and a photographing device configured to take an image of a ground below the photographing device, the method comprising:
an information obtaining step of moving the small-size unmanned aerial vehicle upward from the ground and photographing a state of the ground using the photographing device so as to obtain the image of the ground;
a path setting step of setting, over the image, a flight path for the small-size unmanned aerial vehicle to fly through; and
a flying step of causing the small-size unmanned aerial vehicle to fly through the flight path,
wherein the information obtaining step comprises taking the image at an altitude higher than an altitude at which the small-size unmanned aerial vehicle is caused to fly in the flying step so as to obtain the image including an entire range of a flight that the small-size unmanned aerial vehicle is intended to make in the flying step.

5. A method for controlling a small-size unmanned aerial vehicle, the small-size unmanned aerial vehicle comprising: a plurality of propellers; and a photographing device configured to take an image of a ground below the photographing device, the method comprising:
an information obtaining step of moving the small-size unmanned aerial vehicle upward from the ground and photographing a state of the ground using the photographing device so as to obtain the image of the ground;
a path setting step of setting, over the image, a flight path for the small-size unmanned aerial vehicle to fly through; and
a flying step of causing the small-size unmanned aerial vehicle to fly through the flight path,
wherein the information obtaining step comprises combining a plurality of images together taken while causing the small-size unmanned aerial vehicle to move, so as to constitute the image including an entire range of a flight that the small-size unmanned aerial vehicle is intended to make in the flying step.

6. The method for controlling the small-size unmanned aerial vehicle according to claim 2, wherein the information obtaining step comprises causing the small-size unmanned aerial vehicle to take the image at a fixed point using the photographing device.
